(19) United States
(12) Patent Application Publication
(10) Pub. No.: US 2024/0386219 A1
(43) Pub. Date: Nov. 21, 2024

(54) Systems and Methods for Generating a Custom Playlist based on an Input to a Machine-Learning Model

(71) Applicant: Spotify AB, Stockholm (SE)

(72) Inventors: Enrico PALUMBO, Torino (IT); Gustavo PENHA, Amsterdam (NL); Andreas DAMIANOU, Cambridge (GB); Hugues BOUCHARD, Barcelona (ES); Alice WANG, New York, NY (US); Federico TOMASI, Wembley (GB); Jose Luis REDONDO GARCIA, Cáceres (ES)

(21) Appl. No.: 18/657,446

(22) Filed: May 7, 2024

(30) Foreign Application Priority Data
May 19, 2023 (GR) 20230100415

(51) Int. Cl. G06F 40/58; G06F 16/438; G06N 20/00

(52) U.S. Cl. CPC G06F 40/58; G06F 16/4387; G06N 20/00

(57) ABSTRACT

A computer system associated with a media-providing service is provided, the media-providing service configured to provide a plurality of media items to a plurality of users of the media-providing service. The computer system is configured to perform operations for providing sets of results of media items to users based on input text provided by the users. The operations include receiving, from a user of the media-providing service, an input that includes a text string. The operations include generating, by applying the text string to a trained machine-learning model, a first set of results from the plurality of media items. The operations include retrieving, by applying the text string to a search algorithm, a second set of results being distinct from the first set of results. And the operations include providing, for playback to the user, a representation of the first set of results and the second set of results.

### RELATED APPLICATION

This application claims priority to Greek patent application No. 20230100415, filed May 19, 2023, entitled “Systems and Methods for Generating a Custom Playlist Based on an Input to a Machine-Learning Model,” which is incorporated by reference in its entirety.

### TECHNICAL FIELD

The disclosed embodiments relate generally to media provider systems, and, in particular, to generating a predefined sequence of media items (e.g., a custom playlist) based on applying an input text string to a machine-learning model (e.g., a generative machine-learning system that includes a large-language model).

### BACKGROUND

Recent years have shown a remarkable growth in consumption of digital goods such as digital music, movies, books, and podcasts, among many others. The overwhelmingly large number of these goods often makes navigation and discovery of new digital goods a difficult and tedious task. To cope with the constantly growing complexity of navigating the large number of goods, users create and select playlists to easily organize and access media items, including playlists curated by the users themselves and playlists curated by other parties, such as content providers. But users may wish to generate a playlist without performing copious and tedious user inputs.

### SUMMARY

In the disclosed embodiments, systems and methods are provided for using a machine-learning model (e.g., a large language model) that creates a playlist on-the-fly based on text input (e.g., “fantasy epic metal songs,” “innovative experimental sounds,” “guitar solos to learn”), which may be provided conversationally, and/or as an input in a search user interface. In some embodiments, the machine-learning model generates a first set of results, which may include a plurality of “documents” (e.g., tracks, podcast titles, artist names) that correspond to metadata of the respective media items. For example, the machine-learning model may identify tracks by generating song titles and/or artist names of media items (e.g., via text-to-text generation), which are then mapped (e.g., using a lookup table) to a unique identifier for the tracks, thus allowing a text-to-text model for identifying tracks. In some embodiments, a user interface of an electronic device provides the first set of results (e.g., a generated playlist), which may be provided in conjunction with a second set of results retrieved based on a search algorithm (e.g., without the use of the aforementioned machine-learning model).

For example, a user may provide an input to a search field (e.g., a text string, a conversational query) presented within a user interface that is being displayed by an electronic device. The text string input into the search field may determine what resulting media items will be recommended to the user (e.g., within a search user interface that does not include a messaging environment), based in part on applying the input text to a transformative (e.g., generative) machine-learning model (e.g., a text-to-text generation model), to generate a customized playlist (e.g., an ordered sequence of media items). The input may also be provided (e.g., concurrently) to a search algorithm that is configured to select media items and/or predefined sequences of media items to recommend to the user from an index based on the input text (e.g., Elastic Search). The first set of search results and the second set of search results may be provided to the user concurrently within the same search user interface (e.g., a user interface or set of user interfaces that is specifically configured for searching for media items), allowing the user to select the customized playlist, or one of the other search results.

To that end, in accordance with some embodiments, a method is provided. The method includes operations performed at a server system associated with a media-providing service configured to provide a plurality of media items to a plurality of users of the media-providing service. The operations include receiving, from a user of the media-providing service, an input comprising a text string. The operations include generating a first set of results from the plurality of media items by applying the text string to a trained machine-learning model. The operations include retrieving, by applying the text string to a search algorithm, a second set of results for the plurality of media items, the second set of results being distinct from the first set of results. And the operations include providing, for playback to the user, a representation of the first set of results and the second set of results.

In accordance with some embodiments, an electronic device is provided. The electronic device includes one or more processors and memory storing one or more programs. The one or more programs include instructions for performing any of the methods described herein.

In accordance with some embodiments, a non-transitory computer-readable storage medium is provided. The non-transitory computer-readable storage medium stores one or more programs for execution by an electronic device with one or more processors. The one or more programs comprising instructions for performing any of the methods described herein.

Thus, systems are provided with improved methods for providing relevant content to users based on a query (e.g., a text string).

### BRIEF DESCRIPTION OF THE DRAWINGS

The embodiments disclosed herein are illustrated by way of example, and not by way of limitation, in the figures of the accompanying drawings. Like reference numerals refer to corresponding parts throughout the drawings and specification.

FIG. 1 is a block diagram illustrating a media content delivery system, in accordance with some embodiments.

FIG. 2 is a block diagram illustrating an electronic device, in accordance with some embodiments.

FIG. 3 is a block diagram illustrating a media content server, in accordance with some embodiments.

FIG. 4A-4C are block diagrams illustrating aspects of a computing system 400 for obtaining a plurality of sets of results including media items, including a custom playlist generated by a trained (e.g., fine-tuned) machine-learning model based on a user-input text string, in accordance with some embodiments.

FIGS. 5A-5D are illustrations of user interfaces for presenting sets of search results that include sets of media items, including a custom playlist generated by a machine-learning model based on a user input received by an electronic device, in accordance with some embodiments.

FIGS. 6A-6C are block diagrams illustrating user interfaces for conversationally interacting with a machine-learning model configured to provide a custom playlist of media items to a user based on a user input, in accordance with some embodiments.

FIGS. 7A-7B are flow diagrams illustrating a method for presenting sets of search results that include sets of media items, including a custom playlist generated by a machine-learning model based on an input text string, in accordance with some embodiments.

### DETAILED DESCRIPTION

Reference will now be made to embodiments, examples of which are illustrated in the accompanying drawings. In the following description, numerous specific details are set forth in order to provide an understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are used only to distinguish one element from another. For example, a first electronic device could be termed a second electronic device, and, similarly, a second electronic device could be termed a first electronic device, without departing from the scope of the various described embodiments. The first electronic device and the second electronic device are both electronic devices, but they are not the same electronic device.

The terminology used in the description of the various embodiments described herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context.

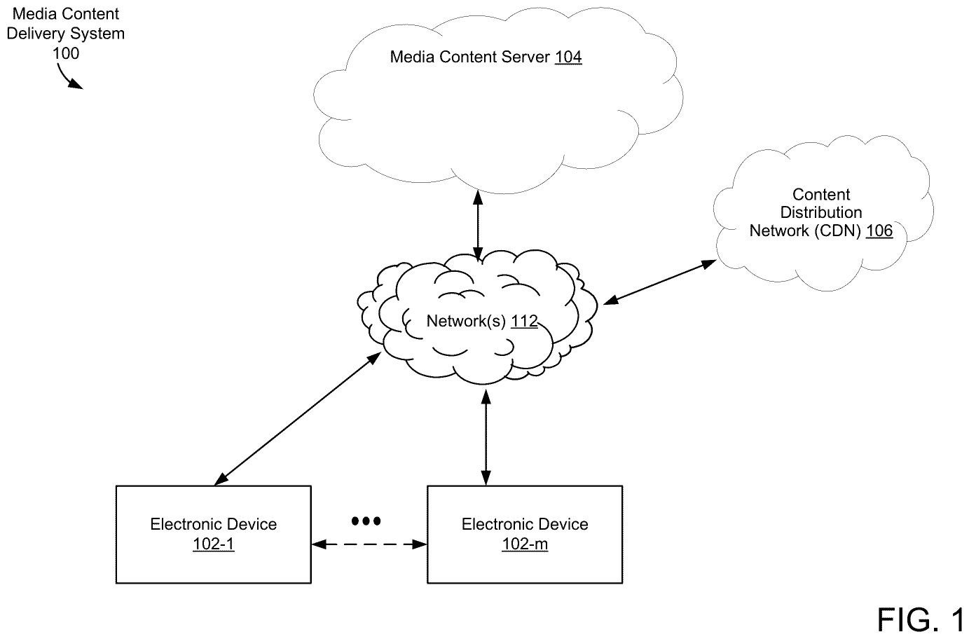

FIG. 1 is a block diagram illustrating a media content delivery system 100, in accordance with some embodiments. The media content delivery system 100 includes one or more electronic devices 102 (e.g., electronic device 102-1 to electronic device 102-m, where m is an integer greater than one), one or more media content servers 104, and/or one or more content distribution networks (CDNs) 106. The one or more media content servers 104 are associated with (e.g., at least partially compose) a media-providing service. The one or more CDNs 106 store and/or provide one or more content items (e.g., to electronic devices 102). In some embodiments, the CDNs 106 are included in the media content servers 104. One or more networks 112 communicably couple the components of the media content delivery system 100. In some embodiments, the one or more networks 112 include public communication networks, private communication networks, or a combination of both public and private communication networks. For example, the one or more networks 112 can be any network (or combination of networks) such as the Internet, other wide area networks (WAN), local area networks (LAN), virtual private networks (VPN), metropolitan area networks (MAN), peer-to-peer networks, and/or ad-hoc connections.

In some embodiments, an electronic device 102 is associated with one or more users. In some embodiments, an electronic device 102 is a personal computer, mobile electronic device, wearable computing device, laptop computer, tablet computer, mobile phone, feature phone, smart phone, an infotainment system, digital media player, a speaker, television (TV), and/or any other electronic device capable of presenting media content (e.g., controlling playback of media items, such as music tracks, podcasts, videos, etc.). Electronic devices 102 may connect to each other wirelessly and/or through a wired connection (e.g., directly through an interface, such as an HDMI interface). In some embodiments, electronic devices 102-1 and 102-m are the same type of device (e.g., electronic device 102-1 and electronic device 102-m are both speakers). Alternatively, electronic device 102-1 and electronic device 102-m include two or more different types of devices.

In some embodiments, electronic devices 102-1 and 102-m send and receive media-control information through network(s) 112. For example, electronic devices 102-1 and 102-m send media control requests (e.g., requests to play music, podcasts, movies, videos, or other media items, or playlists thereof) to media content server 104 through network(s) 112. Additionally, electronic devices 102-1 and 102-m, in some embodiments, also send indications of media content items to media content server 104 through network(s) 112. In some embodiments, the media content items are uploaded to electronic devices 102-1 and 102-m before the electronic devices forward the media content items to media content server 104.

In some embodiments, electronic device 102-1 communicates directly with electronic device 102-m (e.g., as illustrated by the dotted-line arrow), or any other electronic device 102. As illustrated in FIG. 1, electronic device 102-1 is able to communicate directly (e.g., through a wired connection and/or through a short-range wireless signal, such as those associated with personal-area-network (e.g., BLUETOOTH/BLE) communication technologies, radio-frequency-based near-field communication technologies, infrared communication technologies, etc.) with electronic device 102-m. In some embodiments, electronic device 102-1 communicates with electronic device 102-m through network(s) 112. In some embodiments, electronic device 102-1 uses the direct connection with electronic device 102-m to stream content (e.g., data for media items) for playback on the electronic device 102-m.

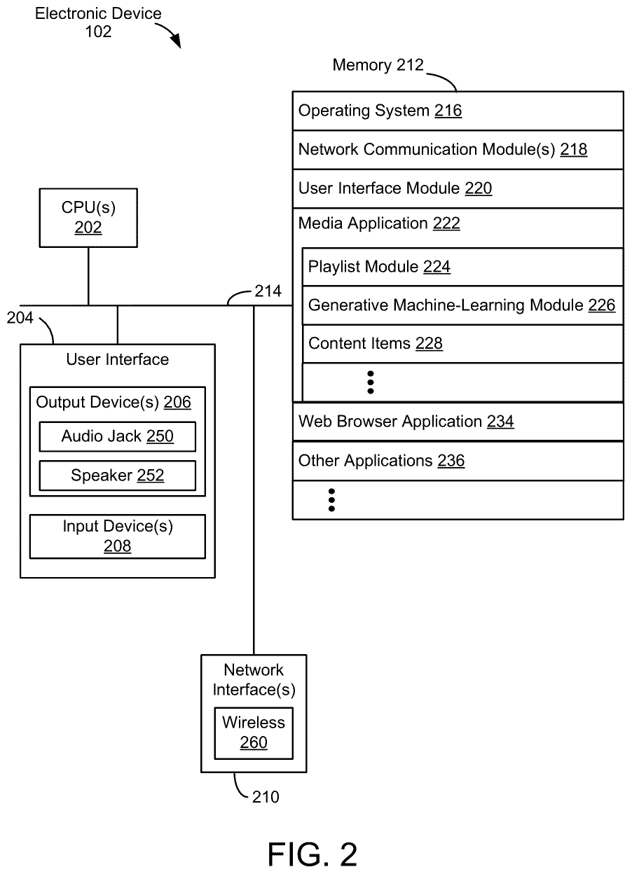

In some embodiments, electronic device 102-1 and/or electronic device 102-m include a media application 222 (FIG. 2) that allows a respective user of the respective electronic device to upload (e.g., to media content server 104), browse, request (e.g., for playback at the electronic device 102), and/or present media content (e.g., control playback of music tracks, playlists, videos, etc.). In some embodiments, one or more media content items are stored locally by an electronic device 102 (e.g., in memory 212 of the electronic device 102, FIG. 2). In some embodiments, one or more media content items are received by an electronic device 102 in a data stream (e.g., from the CDN 106 and/or from the media content server 104). The electronic device(s) 102 are capable of receiving media content (e.g., from the CDN 106) and presenting the received media content. For example, electronic device 102-1 may be a component of a network-connected audio/video system (e.g., a home entertainment system, a radio/alarm clock with a digital display, or an infotainment system of a vehicle). In some embodiments, the CDN 106 sends media content to the electronic device(s) 102.

In some embodiments, the CDN 106 stores and provides media content (e.g., media content requested by the media application 222 of electronic device 102) to electronic device 102 via the network(s) 112. Content (also referred to herein as “media items,” “media content items,” and “content items”) is received, stored, and/or served by the CDN 106. In some embodiments, content includes audio (e.g., music, spoken word, podcasts, audiobooks, etc.), video (e.g., short-form videos, music videos, television shows, movies, clips, previews, etc.), text (e.g., articles, blog posts, emails, etc.), image data (e.g., image files, photographs, drawings, renderings, etc.), games (e.g., 2- or 3-dimensional graphics-based computer games, etc.), or any combination of content types (e.g., web pages that include any combination of the foregoing types of content or other content not explicitly listed). In some embodiments, content includes one or more audio media items (also referred to herein as “audio items,” “tracks,” and/or “audio tracks”).

In some embodiments, media content server 104 receives media requests (e.g., commands) from electronic devices 102. In some embodiments, media content server 104 includes a voice API, a connect API, and/or key service. In some embodiments, media content server 104 validates (e.g., using key service) electronic devices 102 by exchanging one or more keys (e.g., tokens) with electronic device(s) 102.

In some embodiments, media content server 104 and/or CDN 106 stores one or more playlists (e.g., information indicating a set of media content items). For example, a playlist is a set of media content items defined by a user and/or defined by an editor associated with a media-providing service. The description of the media content server 104 as a “server” is intended as a functional description of the devices, systems, processor cores, and/or other components that provide the functionality attributed to the media content server 104. It will be understood that the media content server 104 may be a single server computer, or may be multiple server computers. Moreover, the media content server 104 may be coupled to CDN 106 and/or other servers and/or server systems, or other devices, such as other client devices, databases, content delivery networks (e.g., peer-to-peer networks), network caches, and the like. In some embodiments, the media content server 104 is implemented by multiple computing devices working together to perform the actions of a server system (e.g., cloud computing).

FIG. 2 is a block diagram illustrating an electronic device 102 (e.g., electronic device 102-1 and/or electronic device 102-m, FIG. 1), in accordance with some embodiments. The electronic device 102 includes one or more central processing units (CPU(s), i.e., processors or cores) 202, one or more network (or other communications) interfaces 210, memory 212, and one or more communication buses 214 for interconnecting these components. The communication buses 214 optionally include circuitry (sometimes called a chipset) that interconnects and controls communications between system components.

In some embodiments, the electronic device 102 includes a user interface 204, including output device(s) 206 and/or input device(s) 208. In some embodiments, the input devices 208 include a keyboard, mouse, or track pad. Alternatively, or in addition, in some embodiments, the user interface 204 includes a display device that includes a touch-sensitive surface, in which case the display device is a touch-sensitive display. In electronic devices that have a touch-sensitive display, a physical keyboard is optional (e.g., a soft keyboard may be displayed when keyboard entry is needed). In some embodiments, the output devices (e.g., output device(s) 206) include a speaker 252 (e.g., speakerphone device) and/or an audio jack 250 (or other physical output connection port) for connecting to speakers, earphones, headphones, or other external listening devices. Furthermore, some electronic devices 102 use a microphone and voice recognition device to supplement or replace the keyboard. Optionally, the electronic device 102 includes an audio input device (e.g., a microphone) to capture audio (e.g., speech from a user).

In some embodiments, the one or more network interfaces 210 include wireless and/or wired interfaces for receiving data from and/or transmitting data to other electronic devices 102, a media content server 104, a CDN 106, and/or other devices or systems. In some embodiments, data communications are carried out using any of a variety of custom or standard wireless protocols (e.g., NFC, RFID, IEEE 802.15.4, Wi-Fi, ZigBee, 6LoWPAN, Thread, Z-Wave, Bluetooth, ISA100.11a, WirelessHART, MiWi, etc.). Furthermore, in some embodiments, data communications are carried out using any of a variety of custom or standard wired protocols (e.g., USB, Firewire, Ethernet, etc.). For example, the one or more network interfaces 210 include a wireless interface 260 for enabling wireless data communications with other electronic devices 102, media presentations systems, and/or or other wireless (e.g., Bluetooth-compatible) devices (e.g., for streaming audio data to the media presentations system of an automobile). Furthermore, in some embodiments, the wireless interface 260 (or a different communications interface of the one or more network interfaces 210) enables data communications with other WLAN-compatible devices (e.g., a media presentations system) and/or the media content server 104 (via the one or more network(s) 112, FIG. 1).

In some embodiments, electronic device 102 includes one or more sensors including, but not limited to, accelerometers, gyroscopes, compasses, magnetometer, light sensors, near field communication transceivers, barometers, humidity sensors, temperature sensors, proximity sensors, range finders, and/or other sensors/devices for sensing and measuring various environmental conditions.

Memory 212 includes high-speed random-access memory, such as DRAM, SRAM, DDR RAM, or other random-access solid-state memory devices; and may include non-volatile memory, such as one or more magnetic disk storage devices, optical disk storage devices, flash memory devices, or other non-volatile solid-state storage devices. Memory 212 may optionally include one or more storage devices remotely located from the CPU(s) 202. Memory 212, or alternately, the non-volatile memory solid-state storage devices within memory 212, includes a non-transitory computer-readable storage medium. In some embodiments, memory 212 or the non-transitory computer-readable storage medium of memory 212 stores the following programs, modules, and data structures, or a subset or superset thereof:
an operating system 216 that includes procedures for handling various basic system services and for performing hardware-dependent tasks;
network communication module(s) 218 for connecting the electronic device 102 to other computing devices (e.g., media presentation system(s), media content server 104, and/or other client devices) via the one or more network interface(s) 210 (wired or wireless) connected to one or more network(s) 112;
a user interface module 220 that receives commands and/or inputs from a user via the user interface 204 (e.g., from the input devices 208) and provides outputs for playback and/or display on the user interface 204 (e.g., the output devices 206);
a media application 222 (e.g., an application for accessing a media-providing service of a media content provider associated with media content server 104) for uploading, browsing, receiving, processing, presenting, and/or requesting playback of media (e.g., media items). In some embodiments, media application 222 includes a media player, a streaming media application, and/or any other appropriate application or component of an application. In some embodiments, media application 222 is used to monitor, store, and/or transmit (e.g., to media content server 104) data associated with user behavior. In some embodiments, media application 222 also includes the following modules (or sets of instructions), or a subset or superset thereof:
   a playlist module 224 for storing sets of media items for playback in a predefined order, the media items selected by the user (e.g., for a user-curated playlist) and/or the media items curated without user input (e.g., by the media content provider);
   a generative machine-learning module 226 configured to generate a custom playlist (e.g., an ordered sequence of media items configured for playback in a predefined order) by applying a received input that includes a text string to a trained machine-learning model;
   a content items module 228 for storing media items, including audio items such as podcasts and songs, for playback and/or for forwarding requests for media content items to the media content server;
a web browser application 234 for accessing, viewing, and interacting with web sites; and
other applications 236, such as applications for word processing, calendaring, mapping, weather, stocks, time keeping, virtual digital assistant, presenting, number crunching (spreadsheets), drawing, instant messaging, e-mail, telephony, video conferencing, photo management, video management, a digital music player, a digital video player, 2D gaming, 3D (e.g., virtual reality) gaming, electronic book reader, and/or workout support.

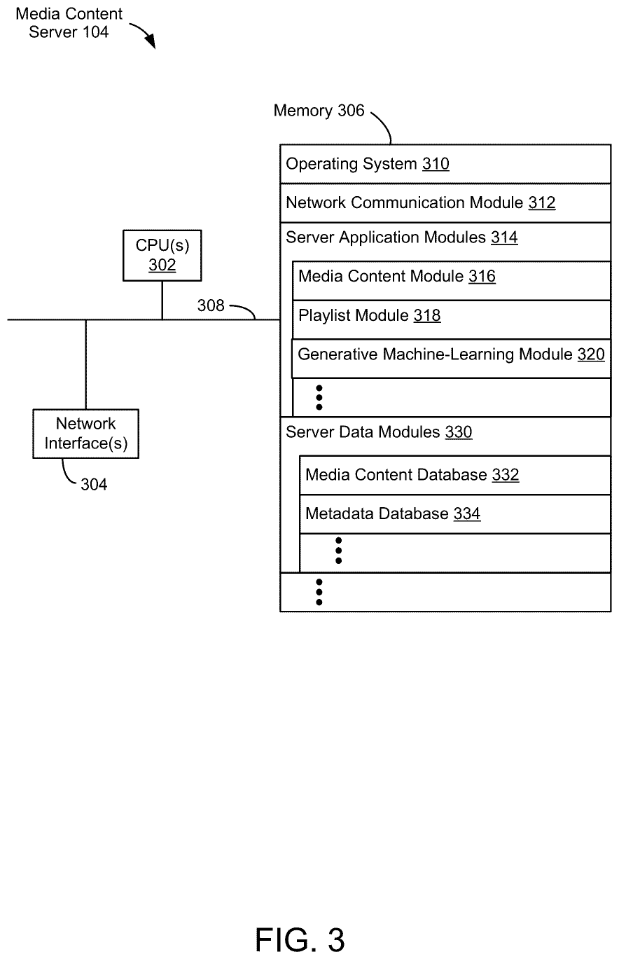

FIG. 3 is a block diagram illustrating a media content server 104, in accordance with some embodiments. The media content server 104 typically includes one or more central processing units/cores (CPUs) 302, one or more network interfaces 304, memory 306, and one or more communication buses 308 for interconnecting these components.

Memory 306 includes high-speed random access memory, such as DRAM, SRAM, DDR RAM, or other random access solid-state memory devices; and may include non-volatile memory, such as one or more magnetic disk storage devices, optical disk storage devices, flash memory devices, or other non-volatile solid-state storage devices. Memory 306 optionally includes one or more storage devices remotely located from one or more CPUs 302. Memory 306, or, alternatively, the non-volatile solid-state memory device(s) within memory 306, includes a non-transitory computer-readable storage medium. In some embodiments, memory 306, or the non-transitory computer-readable storage medium of memory 306, stores the following programs, modules and data structures, or a subset or superset thereof:
an operating system 310 that includes procedures for handling various basic system services and for performing hardware-dependent tasks;
a network communication module 312 that is used for connecting the media content server 104 to other computing devices via one or more network interfaces 304 (wired or wireless) connected to one or more networks 112;
one or more server application modules 314 for performing various functions with respect to providing and managing a content service, the server application modules 314 including, but not limited to, one or more of:
   a media content module 316 for storing one or more media content items and/or sending (e.g., streaming), to the electronic device, one or more requested media content item(s);
   a playlist module 318 for storing and/or providing (e.g., streaming) sets of media content items to the electronic device;
   a generative machine-learning module 226 configured to generate a custom playlist (e.g., an ordered sequence of media items configured for playback in a predefined order) by applying a received input that includes a text string to a trained machine-learning model;
one or more server data module(s) 330 for handling the storage of and/or access to media items and/or metadata relating to the media items; in some embodiments, the one or more server data module(s) 330 include:
   a media content database 332 for storing media items; and
   a metadata database 334 for storing metadata relating to the media items, including a genre associated with the respective media items.

In some embodiments, the media content server 104 includes web or Hypertext Transfer Protocol (HTTP) servers, File Transfer Protocol (FTP) servers, as well as web pages and applications implemented using Common Gateway Interface (CGI) script, PHP Hyper-text Preprocessor (PHP), Active Server Pages (ASP), Hyper Text Markup Language (HTML), Extensible Markup Language (XML), Java, JavaScript, Asynchronous Javascript and XML (AJAX), XHP, Javelin, Wireless Universal Resource File (WURFL), and the like.

Each of the above identified modules stored in memory 212 and 306 corresponds to a set of instructions for performing a function described herein. The above identified modules or programs (i.e., sets of instructions) need not be implemented as separate software programs, procedures, or modules, and thus various subsets of these modules may be combined or otherwise re-arranged in various embodiments. In some embodiments, memory 212 and 306 optionally store a subset or superset of the respective modules and data structures identified above. Furthermore, memory 212 and 306 optionally store additional modules and data structures not described above.

Although FIG. 3 illustrates the media content server 104 in accordance with some embodiments, FIG. 3 is intended more as a functional description of the various features that may be present in one or more media content servers than as a structural schematic of the embodiments described herein. In practice, and as recognized by those of ordinary skill in the art, items shown separately could be combined and some items could be separated. For example, some items shown separately in FIG. 3 could be implemented on single servers and single items could be implemented by one or more servers. In some embodiments, media content database 332 and/or metadata database 334 are stored on devices (e.g., CDN 106) that are accessed by media content server 104. The actual number of servers used to implement the media content server 104, and how features are allocated among them, will vary from one implementation to another and, optionally, depends in part on the amount of data traffic that the server system handles during peak usage periods as well as during average usage periods.

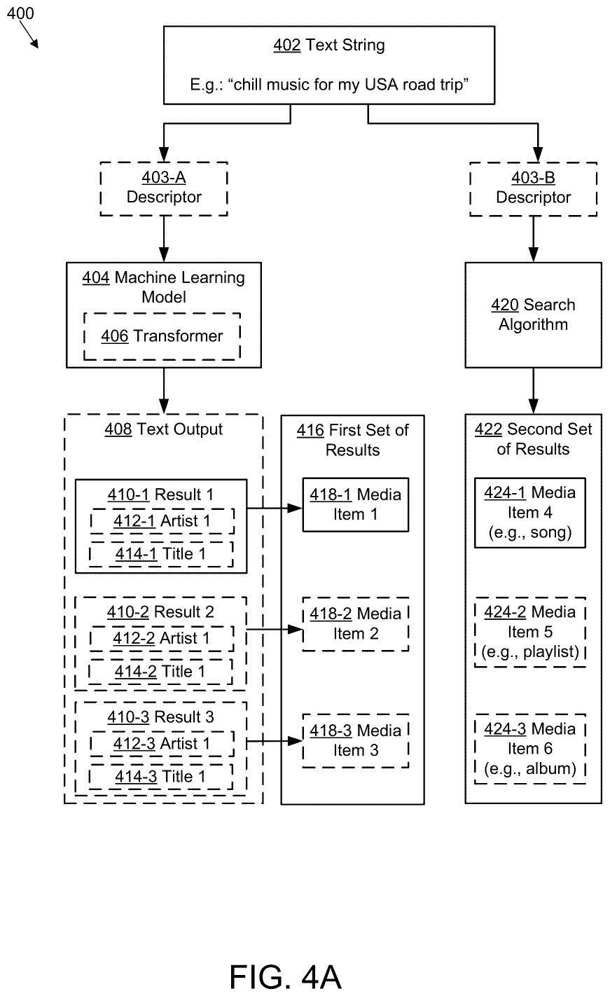

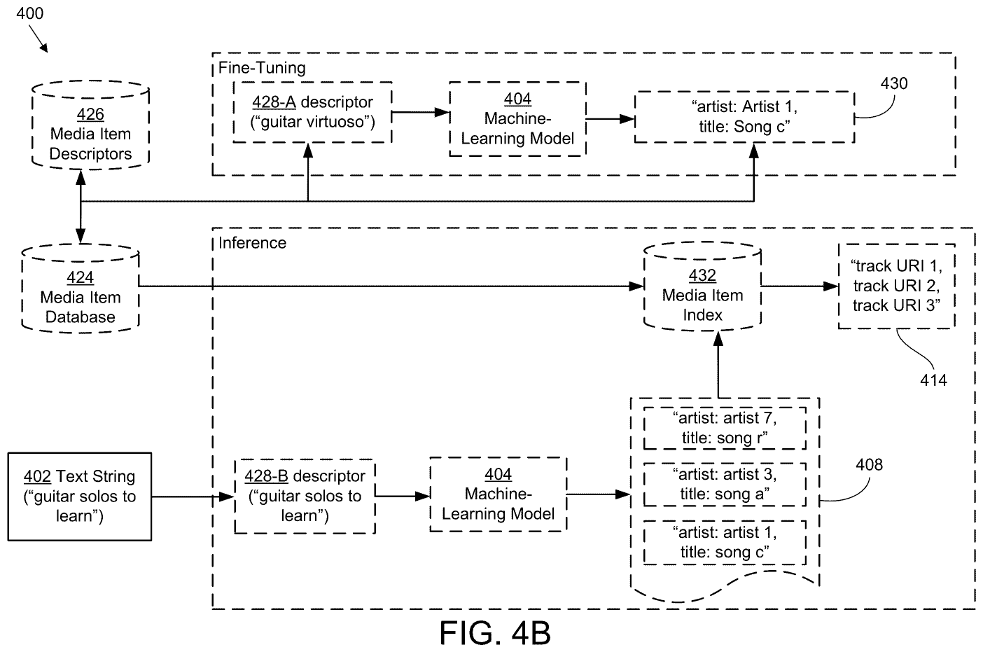

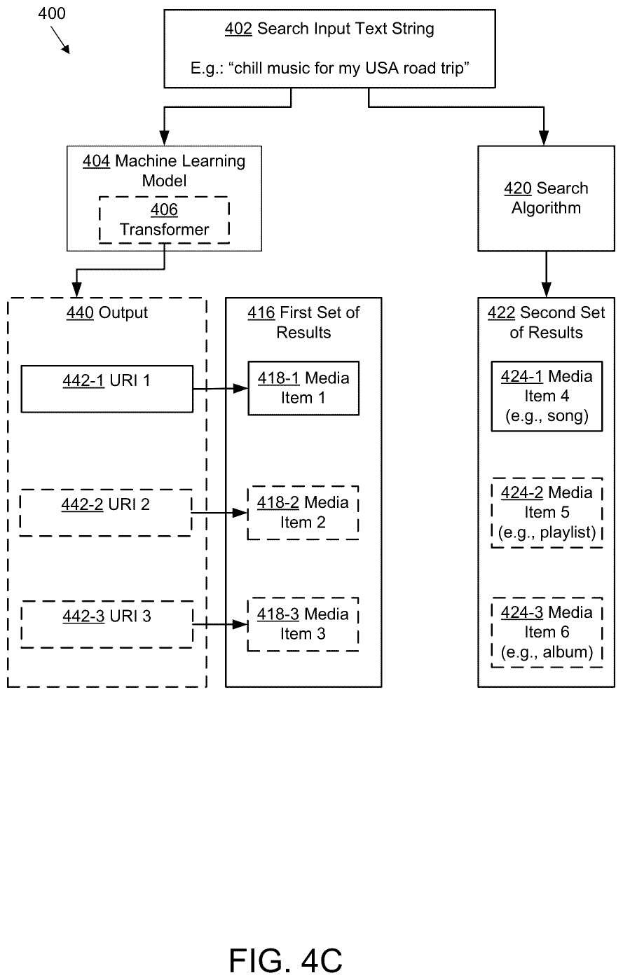

FIG. 4A-4C are block diagrams illustrating aspects of a computing system 400 (e.g., a computing application, instructions for which may be stored at one or more computer-readable storage media stored in memory of the electronic device 102-1 and/or media content server 104) for obtaining a plurality of sets of results including media items, including a custom playlist generated by a trained (e.g., fine-tuned) machine-learning model based on a user-input text string, in accordance with some embodiments. As will be discussed below, the devices, systems, and methods described herein can be used to train a machine-learning model 404 to generate media-item identifiers corresponding to media items, which may be stored or otherwise indexed (e.g., for playback) in a media-item database (of the media-content server 104). The trained machine-learning model (e.g., the machine-learning model 404, after performance of the fine-tuning described with respect to FIG. 4B) can be used to generate a set of results (e.g., a predefined sequence of media items) to provide to a user based on a text input provided by the user. One of skill in the art will appreciate that all the operations described herein can include intermediary steps, and/or alternative approaches not described herein to perform the same or similar operations and/or functions to those described with respect to FIGS. 4A-4C.

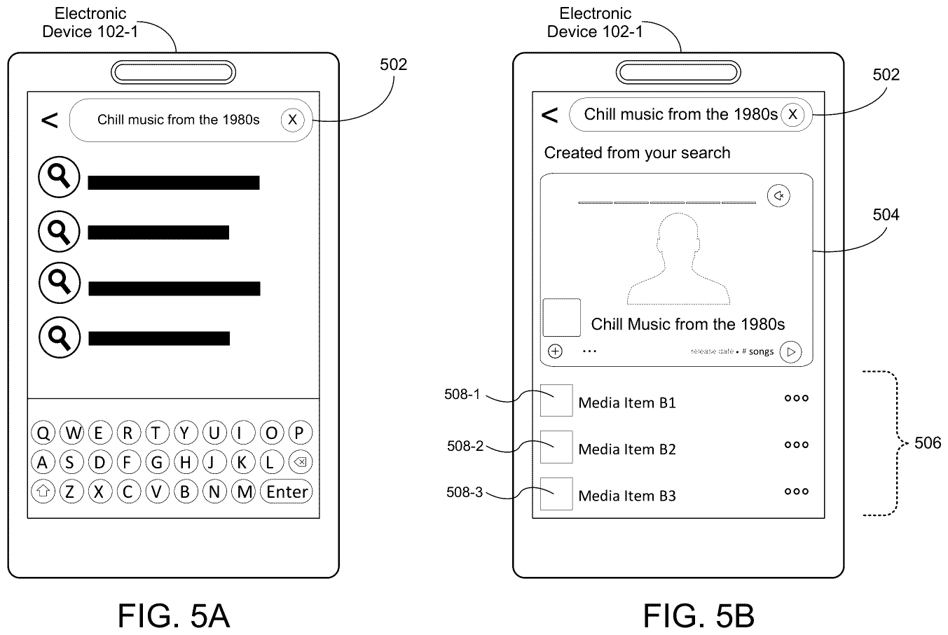

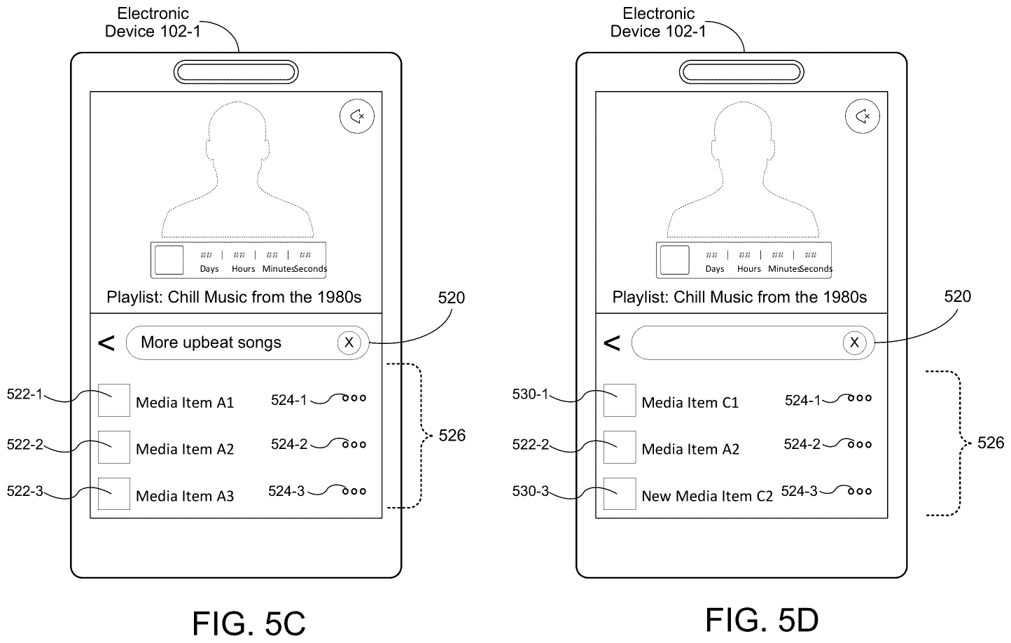

FIG. 4A illustrates aspects of the computing system 400, including components of the computing system 400, and arrows indicating how data flows through the computing system 400. The computing system 400 is configured to receive a text string 402 input by a user (e.g., to a search field user interface element). In some embodiments, the text string 402 is a user input (e.g., a textual input) received at a user interface (e.g., a search user interface as described with respect to FIGS. 5A-5D) of an electronic device (e.g., via a touch-sensitive surface of the display of the electronic device or a microphone capable of detecting voice inputs). In some embodiments, the text string 402 may correspond to a type of media item that a user desires to listen to (e.g., a text input stating: “chill music for my USA road trip”).

In some embodiments, a descriptor may be provided to one or both of the machine-learning model 404 and the search algorithm 420 based on the text string 402 (e.g., one or both descriptors 403-A and 403-B). In some embodiments, the descriptor may be the text string 402 itself. In some embodiments, the descriptor may be a pre-processed and/or re-formatted version of the text string 402, such that the descriptor, as provided to the machine-learning model and/or the search algorithm, is more compatible with aspects and/or functions of the respective model receiving the descriptor. For example, the descriptor may contain grammatical errors, spelling errors, and the like, and/or may be based on an audio input that was not precisely translated by speech-translating service of the computing system. In some embodiments, different descriptors may be provided to the machine-learning model 404 and the search algorithm 420 based on the text string 402.

The text string 402 is provided to a machine-learning model 404, and the text string 402 is also provided to a search algorithm 420 that is distinct and different from the machine-learning model 404. In some embodiments, the machine-learning model 404 is or includes a large-language model designed to generate text (e.g., human-like language) or other output data (e.g., a weighted vector). In some embodiments, the search algorithm 420 is configured to find (e.g., locate an index of) a specific target within a larger dataset or search space.

In some embodiments, the machine-learning model 404 is or includes a transformer 406, which is trained on text data to enable the machine-learning model 404 to generate sets of results. In some embodiments, as will be discussed in more detail below with respect to FIG. 4B, the machine-learning model 404 is or includes a large-language model that includes a pre-trained transformer-based language model, and the machine-learning model is re-trained (e.g., via the fine-tuning process described in FIG. 4B) using data from a media-providing service to perform the specific functions described herein.

In some embodiments, the machine-learning model generates a text output 408 that includes a first set of results based on the descriptor provided to the machine-learning model 404 (e.g., a first result 410-1, a second result 410-2, and/or a third result 410-3). In some embodiments, each result of the first set of results includes one or more media-item identifiers that are generated by the machine-learning model 404. In some embodiments, the media-item identifiers correspond to metadata of media items configured to be provided for playback by a media-providing service (e.g., the media content server 104). For example, the first result 410-1 may include a first media-item identifier 412-1 identifying an artist associated with the result 410-1 (e.g., “Artist 1”), and the first result 410-1 may include a second media-item identifier 412-2 identifying a title associated with the result 410-1 (e.g., “Title 1”).

In some embodiments, the media-item identifiers generated in the first set of results are compared to media items of the media-providing service to determine which media items the media-item identifiers correspond to. In some embodiments, media-item identifiers may include extraneous words or letters, and a comparison is performed to determine if one or more of the media-item identifiers satisfy threshold similarity criteria to correspond to media items of the media-providing service.

In some embodiments, the text string 402 is also applied (e.g., concurrently) to the search algorithm 420, and the search algorithm 420 is configured to generate a second set of results 422 based on the text string 402. In some embodiments, the second set of results 422 includes media items that comprise individual tracks (e.g., songs, podcasts, and/or audiobooks, such as a media item 4 424-1), including media items that are or include a predefined sequence of individual tracks (e.g., predefined playlists and/or producer-created albums, such as a media item 5 424-2 that corresponds to a playlist, and a media item 6 424-3 corresponding to an album).

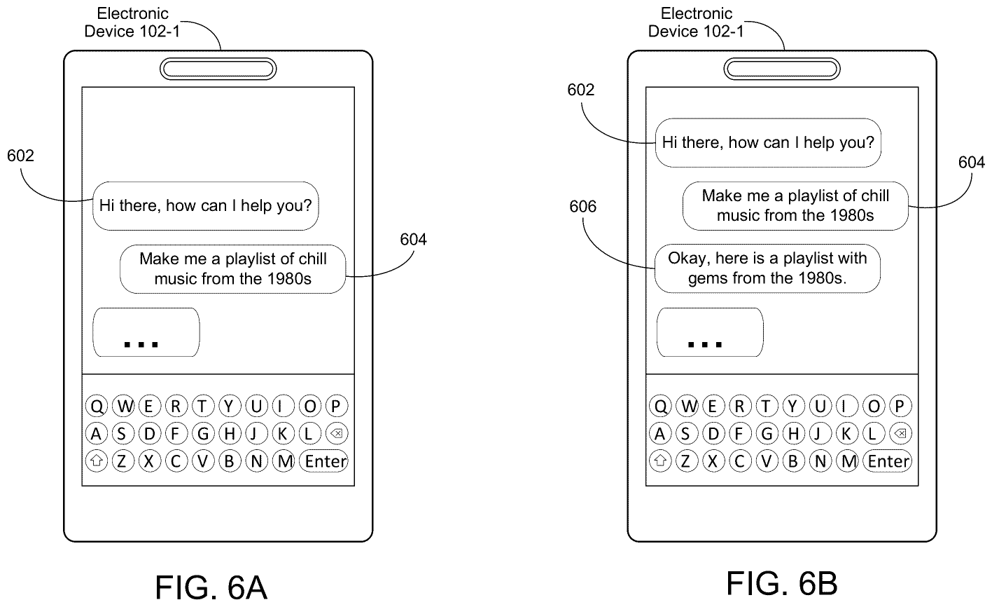

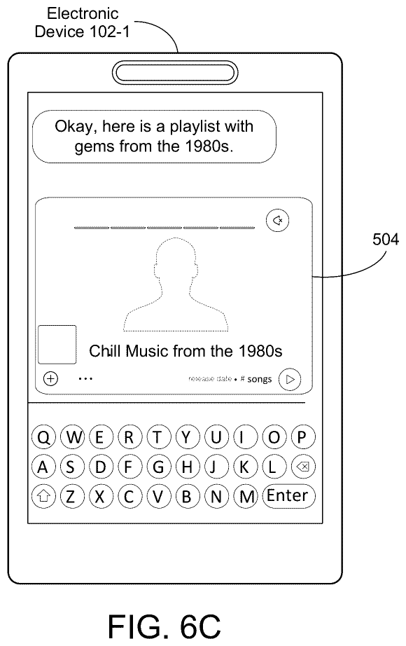

As will be described in more detail with respect to FIGS. 5A-5D, in some embodiments, a first representation of the first set of results 416 can be presented in a user interface (e.g., a search user interface) in conjunction with the second set of results 422. As will be described in more detail with respect to FIGS. 6A-6C, in some embodiments, a representation of the first set of results is provided without the second set of results (e.g., in a messaging environment that includes a message-thread user interface).

FIG. 4B illustrates additional details of the computing system 400 described with respect to FIG. 4A. In particular, FIG. 4B illustrates aspects of a fine-tuning (e.g., training) process for machine-learning model 404, as well as an inference process for machine learning model 404. The computer system 400 shown in FIG. 4B includes or is in communication with a media item database 424 that stores media items, as well as a media item descriptor database 426 that stores media item descriptors in association with the media items stored in the media item database 424 (e.g., such that each media item in media item database 424 is associated with, or tagged with, a set of zero or more descriptors). The descriptors are used as text to fine-tune the training of a text-to-text language model, e.g., that (prior to fine-tuning) has not specifically been trained to generate text corresponding to media items. For example, text descriptor 428-A (“guitar virtuoso”) is associated with artist 1, song C in media item descriptor database 426. During the fine-tuning phase, artist 1, song C is used as a ground truth such that machine learning model 404 is re-trained to produce text of metadata corresponding to artist 1, song C in response to descriptor 428-A. As a result, during the inference phase, when computer system 400 receives a similar (but not identical) text string (e.g., “guitar solos to learn”), text of metadata for artist 1, song C is among the text output 408 produced by machine learning model 404. Computer system 400 then using a media item index 432 to lookup track URIs 414 for the text output 408 (which are text strings of metadata).

In some embodiments, the machine-learning model is also trained and/or re-trained using data from a media-providing service, including listening preferences of users and/or indexes (e.g., defined subsets) of media items. In some embodiments, the data from the media-providing service is more current than the text data that is used to train the large language model.

FIG. 4C illustrates another example of a computing system 401 that is analogous to computing system 400, except that, rather than being configured to output text corresponding to metadata of media items, computer system 401 directly outputs universal resource identifiers (URLs) associated with media items (track URIs) (e.g., without the need for a look-up). That is, in some embodiments, the machine-learning model 404 can be configured to generate different media-item identifiers than artist and title, such as output 440 that includes track URIs 442-1, 442-2, and 442-3 that correspond to the respective media items 418-1, 418-2, and 418-3 of the first set of results 416. In some embodiments, a similar fine-tuning process as compared to the one shown in FIG. 4B is used to train and/or re-train the machine-learning model 404 to generate track URIs corresponding to descriptors of media items from the media item database 428, except that text descriptor, URI dyads are used in place of text descriptor, metadata text dyads shown in FIG. 4B.

FIGS. 5A-5D are block diagrams illustrating user interfaces for presenting sets of search results that include sets of media items, including a custom playlist generated by a machine-learning model based on a user input received by an electronic device (the electronic device 102-1, the media-content server 104-1), in accordance with some embodiments. FIG. 5A illustrates a search field user interface element 502 for allowing a user to search for media items (e.g., to select playback of recommended media items based on an input text). The search field user interface element 502 includes a text string that was input by a user stating, “chill music from the 1980s.”

FIG. 5B illustrates the user interface shown in FIG. 5A after the text string input into the search field user interface element 502 has been applied to a machine-learning model (e.g., the machine-learning model 404) and a search algorithm (e.g., the search algorithm 420). A composite media item 504 (e.g., a composite media item) is displayed below the search field user interface element 502. In some embodiments, the composite media item corresponds to a first set of results generated by the machine-learning model, described with reference to FIG. 4A-4C.

The user interface shown in FIG. 5B also includes a plurality of user interface elements 508-1, 508-2, 508-3, and 508-4, which correspond to a second set of results (e.g., individual media items and predefined sequences of media items) retrieved by applying the text string input to the search field user interface element 502 to a search algorithm (e.g., a weighted index search, such as Elastic Search). For example, the search algorithm may be configured to match one or more words of the text string input by the user to one or more words of a playlist or media item, such that the resulting set of search results includes media items that include one or more words of the input text. In some embodiments, the search results (e.g., the second set of results) are displayed individually with a different visual prominence than the composite media item representing the first set of results.

In some embodiments, the user can select the composite media item 504 to cause a first type of operation, and the user can select an affordance of a plurality of affordances 508-1, 508-2, 508-3, that each correspond to respective media items 508-1, 508-2, and 508-3 provided based on applying the input text to a search algorithm (e.g., the search algorithm 420) to cause a second operation, distinct from the first operation.

In some embodiments, the user can select one of the user interface elements 508-1 to 508-3 to initiate playback of the respective media item corresponding to the selected user interface element. In some embodiments, when the user selects one of the respective search results of the second set of results, a different user interface is presented that does not include any respective media items from the first set of results (e.g., a now playing view for the selected search result, or an artist page for the selected search result, etc.). In some embodiments, the user can select the composite media item 504 to initiate playback of the generated ordered sequence of media items corresponding to the composite media item 504 while presenting another search user interface (e.g., the search user interface shown in FIG. 5C).

FIG. 5C illustrates another user interface associated with the first set of results that was represented by the composite media item 504 shown in FIG. 5B. In some embodiments, the other user interface is presented in response to a user input directed to the composite media item 504.

The user interface shown in FIG. 5C includes another search user interface element 510. The other user interface includes another text input element 520 that includes another text input field, and the other text input field includes a second text string input by the user. The other text input field allows the user to refine the generated playlist in a conversation way, e.g., by stating “add more upbeat songs.” The other user interface includes representations of respective results of the first set of results that was generated by applying the first text string to the machine-learning model.

As shown in FIG. 5D, in response to the user input to the text input interface element 520, the first set of results can be modified, and/or re-generated (e.g., in real-time, such that different results are presented below the user interface element 520 after the user submits the second text string. For example, the displayed media items in FIG. 5D include media items 530-1 and 530-3 which replace the media items 522-1 and 522-3 based on the text input to the search field user interface element 520.

It should be understood that, although FIGS. 5A-5D describe text inputs to the search field user interface elements 502 and 520 to generate the first set of results and the second set of results that include respective sets of media items, in some embodiments a speech input (or other user interface modality) may be used to trigger analysis operations.

FIGS. 6A-6C are block diagrams illustrating user interfaces for interacting with a conversational user interface configured to provide a set of media items to a user based on a conversational user input, in accordance with some embodiments. That is, the interactions shown in FIGS. 6A-6C may include similar operations to those performed with respect to FIGS. 5A-5D, except that the interactions shown in FIGS. 6A-6C occur within a message-thread user interface that includes electronic messages generated by a chatbot (e.g., a conversational agent).

In FIG. 6A, an automatically generated electronic message 602 is provided by the chatbot, which prompts the user to provide an input (e.g., stating “Hi there, how can I help you?”). An electronic message 604 corresponds to a response provided by the user in the form of input text (which may alternatively be provided as a speech input as described with respect to FIGS. 5A-5D), including a request to make a playlist (e.g., text stating “Make me a playlist of chill music from the 1980s”).

In FIG. 6B, another automatically generated electronic message 606 is provided from the chatbot, indicating that a playlist has been generated for the user based on the input text provided in the electronic message 604 (e.g., stating “Okay, here is a playlist with gems from the 1980s”). In some embodiments, the chatbot provides the response message after a machine-learning model has generated a set of search results based on the electronic message 604 provided by the user. In some embodiments, a descriptor is applied to the machine-learning model that is a modified version of the text comprising the electronic message 604. For example, a descriptor stating “playlist of chill music from the 1980s” may be provided to the machine-learning model 604, which may be based on a determination that the resulting descriptor is more similar in format to text descriptors that were used to fine tune the machine-learning model.

FIG. 6C shows the composite media item 504 being presented within the message-thread user interface based on applying the content of the electronic message 604 to the machine-learning model (e.g., the machine-learning model 404). That is, a same set of results can be generated by applying the contents of the electronic message 604 to the machine-learning model, as was generated based on the user's input to the search field user interface element 502 in FIG. 5A. In some embodiments, the machine-learning model is configured to receive descriptors corresponding to conversational messages provided in a conversation with a chatbot, instead of text inputs provided to a search field. That is, in some embodiments, the contents of the electronic message 604 may not be modified when provided as a descriptor to the machine-learning model, and instead, the input text provided to the search field user interface element 502 may be modified to correspond to conversational text. That is, in some embodiments, chatbot conversational logic as shown in FIGS. 6A-6C may be performed outside of a messaging context (e.g., within a user interface that does not include a message thread, such as a search user interface).

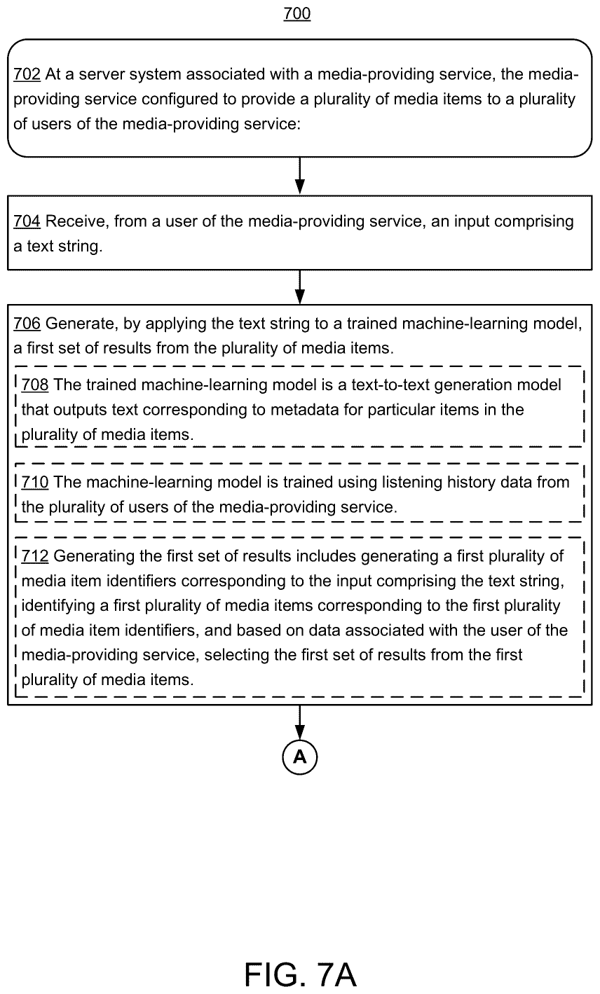

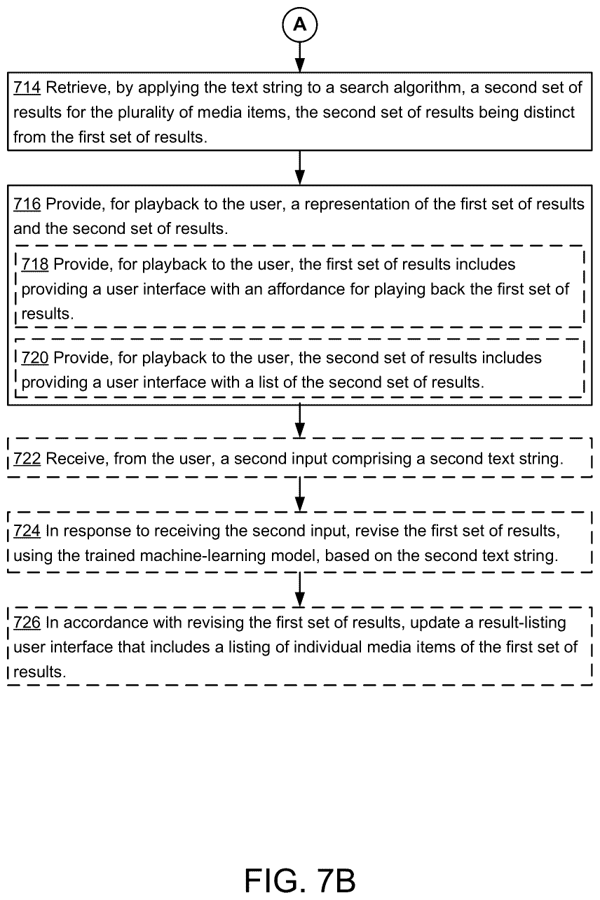

FIGS. 7A-7B are flow diagrams illustrating a method 700 of presenting two sets of search results, including a playlist generated by applying a machine-learning model to a text string input by a user, in accordance with some embodiments. Method 700 may be performed at an electronic device (e.g., media content server 104 and/or electronic device(s) 102) having one or more processors and memory storing instructions for execution by the one or more processors. In some embodiments, the method 700 is performed by executing instructions stored in the memory (e.g., memory 212, FIG. 2, memory 306, FIG. 3) of the electronic device. In some embodiments, the method 700 is performed by a combination of the server system (e.g., including media content server 104 and CDN 106) and a client device.

Referring now to FIG. 7A, the operations of the method 700 are performed at a server system (702) associated with a media-providing service (e.g., the media content server 104; FIG. 1), in accordance with some embodiments. The media-providing service is configured to provide a plurality of media items to a plurality of users of the media-providing service.

The server system receives (704), from a user of the media-providing service, an input comprising a text string (e.g., the first text string input to the search field user interface element 502 in FIG. 5A). In some embodiments, the server system receives a query from the user as a voice input, and subsequently translates the voice input into the text string. In some embodiments, the input is provided in a search user interface. In some embodiments, the input is provided in a conversation between the user and a chatbot (e.g., as shown by the interactions with the message-thread user interface in FIGS. 6A-6C).

The server system generates (706), by applying the text string to a trained machine-learning model, a first set of results (e.g., which may be provided as a representation of the first set of results, such as the composite media item 504 shown in FIG. 5B) from the plurality of media items. In some embodiments, the machine-learning model generates the first set of results as a single input. In some embodiments, the machine-learning model outputs a plurality of media-item identifiers corresponding to a plurality of media items, which the server system may reduce and/or re-sequence based on a user's listening preferences. In some embodiments, the trained machine-learning model is configured to generate new text, distinct from input text, based on semantic associations between the input text and other textual content (e.g., via transforming of the input text).

In some embodiments, the trained machine-learning model is (708) a text-to-text generation model (e.g., a large-language model as described with respect to FIGS. 4A-4C) that outputs text corresponding to metadata (e.g., media-item identifiers, such as the media-item identifiers 412-1 to 412-3 and 414-1 to 414-3 shown in FIG. 4A, or the media-item identifiers shown in FIG. 4C) for particular items in the plurality of media items (e.g., a concatenation of a media-item title and an artist name). In some embodiments, the trained machine-learning model is a large-language model. In some embodiments, the machine-learning model transforms the input text such that the output text does not contain any portion of the input text.

In some embodiments, the machine-learning model is (710) trained using listening history data from the plurality of users of the media-providing service. In some embodiments, the machine learning model comprises a plurality of weights. In some embodiments, the machine-learning model updates weights or other aspects of the machine-learning model using the listening history data from the plurality of users of the media-providing service.

In some embodiments, the trained machine-learning model is trained and/or re-trained (e.g., fine-tuned) using descriptors associated a subset of the plurality of media items (e.g., an index of the media item database 428 shown in FIG. 4B). That is, the machine-learning model may have been trained to perform a set of natural language operations, and subsequently re-trained based on data, such as a subset of media items available via the media-providing service (e.g., media items stored at the media content server 104). In some embodiments, data used to re-train the trained machine-learning model, including the subset of the plurality of media items, is more recent (e.g., newer) than the data that was used to train the machine-learning model. In some embodiments, the machine-learning model generates the first set of results based on a subset of the plurality of media items that are configured to be provided by the media-providing service (e.g., an index, a characterized subset, such as the top one million songs in the United States). In some embodiments, the second set of results is based on the plurality of media items that are configured to be provided by the media-providing service.

In some embodiments, generating the first set of results includes generating (712) a first plurality of media item identifiers (e.g., metadata, such as track names, artist names, track URIs) corresponding to the input comprising the text string (e.g., a conversational input, such as “top songs for learning guitar”), identifying a first plurality of media items corresponding to the first plurality of media item identifiers, and based on data associated with the user of the media-providing service (e.g., the user's listening history and/or listening preferences), selecting the first set of results from the first plurality of media items. In some embodiments, each media item identifier of the first plurality of media item identifiers corresponds to a cluster of related media items, and the method further includes, for each respective media-item identifier of the plurality of media-item identifiers, selecting each media item of the first set of results from a respective cluster corresponding to the respective media item identifier. In some embodiments, each media-item identifier of the first plurality of media-item identifiers corresponds to a cluster of related media items, and the method includes, for each respective media-item identifier of the plurality of media-item identifiers, selecting each media item of the first set of results from a respective cluster corresponding to the respective media item identifier.

The server system retrieves (714), by applying the text string to a search algorithm, a second set of results for the plurality of media items, the second set of results being distinct from the first set of results. For example, a search algorithm (e.g., the search algorithm 420 described with respect to FIG. 4B) may select a media item by determining an index associated with the media item based on a weighted value function.

In some embodiments, the first set of results is an ordered sequence of media items generated based on transforming the text string into additional text strings (e.g., transformations of the input text, which may be used as media-item identifiers), and identifying media items that correspond to the additional text strings. In some embodiments, the second set of results includes individual media items and predefined ordered sequences of media items (e.g., previously constructed playlists) that correspond to the text string. In some embodiments, generating the ordered sequence of media items includes (i) generating a first ordered sequence of media items by applying the text string to the trained machine-learning model without accounting for the listening preferences of the user, and (ii) modifying (e.g., re-ordering and narrowing down) the first ordered sequence of media items based on the listening preferences of the user.

The server system provides (716), for playback to the user, a representation of the first set of results and the second set of results. In some embodiments, providing, for playback to the user, the first set of results includes (718) providing a user interface with an affordance for playing back the first set of results. In some embodiments, the affordance for playing back the first set of results comprises a play button. In some embodiments, the affordance for playing back the first set of results comprises a representation of the first set of results (e.g., with a playlist title that matches the text string). In some embodiments, in response to selection of the affordance for playing back the first set of results, a user interface provides the user with a list of the first set of results. In some embodiments, playback automatically begins with display of the user interface with the list of the first set of results (e.g., upon displaying the user interface shown in FIG. 5B). Alternatively, the user may select an affordance within the list of the first set of results (e.g., a play button or a particular item in the list) to initiate playback.

In some embodiments, providing, for playback to the user, the second set of results includes (720) providing a user interface with a list of the second set of results (e.g., each item in the list is a selectable affordance for playing back a particular result from the second set of results, such as the media items 508-1 to 508-3 that may be played back based on selecting the respective affordances 510-1 to 510-3 shown in FIG. 5B). That is, a single affordance may be provided for playing back the first set of results, while a plurality of affordances corresponding to each respective result may be provided for the second set of results.

In some embodiments, the server system receives (722), from the user, a second input comprising a second text string. In response to receiving the second input, the server system revises (724) the first set of results, using the trained machine-learning model, based on the second text string. For example, in response to the text input provided to the search field user interface element 520 in FIG. 5C, the first set of results is modified to include the media items 530-1 and 530-3. In some embodiments, the server system receives the second text string from a prompt in the user interface with the list of the first set of results. In some embodiments, second text string is received while the first set of results is being provided. In some embodiments, after the first representation of the first set of search results is being provided, receiving a second input causes navigation to another user interface that includes a second representation of the first set of results and a field for providing a third input that includes a second text string.

In some embodiments, in accordance with revising the first set of results, the server system updates (726) a result-listing user interface that includes a listing of individual media items of the first set of results (e.g., in real-time while continuing to provide the result-listing interface and a search prompt for receiving additional user inputs). In some embodiments the server system receives the second text string from a prompt in the user interface with the list of the first set of results. In some embodiments, second text string is received while the first set of results is being provided. In some embodiments, after the first representation of the first set of search results is being provided, receiving a second input causes navigation to another user interface that includes a second representation of the first set of results and a field for providing a third input that includes a second text string. In some embodiments, the machine-learning model receives the first set of results with the second text string.

Although FIGS. 7A-7B illustrate a number of logical stages in a particular order, stages which are not order dependent may be reordered and other stages may be combined or broken out. Some reordering or other groupings not specifically mentioned will be apparent to those of ordinary skill in the art, so the ordering and groupings presented herein are not exhaustive. Moreover, it should be recognized that the stages could be implemented in hardware, firmware, software, or any combination thereof.

The foregoing description, for purpose of explanation, has been described with reference to specific embodiments. However, the illustrative discussions above are not intended to be exhaustive or to limit the embodiments to the precise forms disclosed. Many modifications and variations are possible in view of the above teachings. The embodiments were chosen and described in order to best explain the principles and their practical applications, to thereby enable others skilled in the art to best utilize the embodiments and various embodiments with various modifications as are suited to the particular use contemplated.

What is claimed is:

1. A method comprising:
at a computer system associated with a media-providing service, the media-providing service configured to provide a plurality of media items to a plurality of users of the media-providing service:
receiving, from a user of the media-providing service, an input comprising a text string;
generating, by applying the text string to a trained machine-learning model, a first set of results from the plurality of media items;
retrieving, by applying the text string to a search algorithm, a second set of results for the plurality of media items, the second set of results being distinct from the first set of results; and
providing, for playback to the user, a representation of the first set of results and the second set of results.

2. The method of claim 1, wherein the trained machine-learning model is a text-to-text generation model that outputs text corresponding to metadata for particular items in the plurality of media items.

3. The method of claim 1, further comprising:
receiving, from the user, a second input comprising a second text string; and
in response to receiving the second input, revising the first set of results, using the trained machine-learning model, based on the second text string.

4. The method of claim 3, further comprising:
in accordance with revising the first set of results, updating a result-listing user interface that includes a listing of individual media items of the first set of results.

5. The method of claim 1, further comprising training the machine-learning model using listening history data from the plurality of users of the media-providing service.

6. The method of claim 1, wherein providing, for playback to the user, the first set of results includes providing a user interface with an affordance for playing back the first set of results.

7. The method of claim 1, wherein providing, for playback to the user, the second set of results includes providing a user interface with a list of the second set of results.

8. The method of claim 1, wherein generating the first set of results includes:
generating a first plurality of media item identifiers corresponding to the input comprising the text string;
identifying a first plurality of media items corresponding to the first plurality of media item identifiers; and
based on data associated with the user of the media-providing service, selecting the first set of results from the first plurality of media items.

9. The method of claim 1, wherein the trained machine-learning model is re-trained using a subset of the plurality of media items.

10. The method of claim 1, wherein:
the first set of results is an ordered sequence of media items generated based on transforming the text string into additional text strings, and identifying media items that correspond to the additional text strings; and
the second set of results includes individual media items and predefined ordered sequences of media items that correspond to the text string.

11. The method of claim 10, wherein generating the ordered sequence of media items includes:
generating a first ordered sequence of media items by applying the text string to the trained machine-learning model without accounting for listening preferences of the user; and
modifying the first ordered sequence of media items based on one or more listening preferences of the user.

12. A computer system, comprising:
one or more processors; and
memory storing one or more programs, the one or more programs including a set of instructions for performing a set of operations, comprising:
receiving, from a user of the media-providing service, an input comprising a text string;
generating, by applying the text string to a trained machine-learning model, a first set of results from the plurality of media items;
retrieving, by applying the text string to a search algorithm, a second set of results for the plurality of media items, the second set of results being distinct from the first set of results; and
providing, for playback to the user, a representation of the first set of results and the second set of results.

13. The computer system of claim 12, wherein the trained machine-learning model is a text-to-text generation model that outputs text corresponding to metadata for particular items in the plurality of media items.

14. The computer system of claim 12, wherein the set of operations further comprises:
receiving, from the user, a second input comprising a second text string; and
in response to receiving the second input, revising the first set of results, using the trained machine-learning model, based on the second text string.

15. The computer system of claim 14, wherein the set of operations further comprises:
in accordance with revising the first set of results, updating a result-listing user interface that includes a listing of individual media items of the first set of results.

16. The computer system of claim 12, wherein the set of operations further comprises training the machine-learning model using listening history data from the plurality of users of the media-providing service.

17. The computer system of claim 12, wherein providing, for playback to the user, the first set of results includes providing a user interface with an affordance for playing back the first set of results.

18. The computer system of claim 12, wherein providing, for playback to the user, the second set of results includes providing a user interface with a list of the second set of results.

19. A non-transitory computer readable storage medium storing one or more programs, the one or more programs including a set of instructions for performing a set of operations, comprising:
receiving, from a user of the media-providing service, an input comprising a text string;
generating, by applying the text string to a trained machine-learning model, a first set of results from the plurality of media items;
retrieving, by applying the text string to a search algorithm, a second set of results for the plurality of media items, the second set of results being distinct from the first set of results; and
providing, for playback to the user, a representation of the first set of results and the second set of results.
